(19) United States
(12) Patent Application Publication
(10) Pub. No.: US 2002/0103030 A1
(43) Pub. Date: Aug. 1, 2002

(54) Game playing system having site connectibility using URL allocated by management server over network

(76) Inventor: Toshihiko Muramatsu, Toyooka-mura (JP)

Correspondence Address: Pillsbury Winthrop LLP, Intellectual Property Group, Suite 2800, 725 South Figueroa Street, Los Angeles, CA, 90017-5406, US

(21) Appl. No.: 10/058,366

(22) Filed: Jan. 28, 2002

(30) Foreign Application Priority Data
Jan. 31, 2001 (JP) P2001-024954

(51) Int. Cl. A63F 13/00

(52) U.S. Cl. 463/42

(57) ABSTRACT

A game playing system comprises a game device such as a pachinko machine, a management server, and at least one shop server, all of which are interconnected together via a network. When the player operates the game device to play a prescribed game (e.g., pachinko game), its score is communicated to the management server. Hence, the management server communicates to the game device a URL specifying the shop server that provides commodities or services as a prize for a consideration of the score of the prescribed game. The player selects a desired commodity or service as the prize, so that the shop server automatically sends it to the player without charging its cost to the player. The game device can be installed at home or at a prescribed game hall (e.g., pachinko hall).

### BACKGROUND OF THE INVENTION

1. Field of the Invention

This invention relates to game playing machines and systems that are connectible to networks such as the Internet. In addition, this invention also relates to game prize providing methods for providing users with prizes or awards online in response to scores at specific game sites specified by universal resource locators (URL) allocated by management servers over networks.

2. Description of the Related Art

There are conventionally provided a variety of game playing machines and systems, which may be classified into two types, namely, business use and home use. Amusement or entertainment places such as game halls are equipped with various types of game playing machines such as pachinko machines, patisuro (or pachisuro) machines, arcade game machines, pinball machines, and slot machines. Pachinko machines and patisuro machines are common in Japan as Japanese style pinball machines, wherein they are worked by the insertion of a coin or a card to allow small metal balls to be shot across a board having pins so that points of score may be counted and accumulated in response to user's operations. That is, the pachinko machine provides the user with prescribed multiples of small metal balls that successively fall into prescribed holes on the board without being discharged, so that the total number of balls gained by the user is counted as the pachinko game score. After completion of a pachinko game, the user accesses the so-called commodity exchanger (or game prize exchange system) to select desired commodities or articles that are displayed behind show windows in the pachinko hall in response to the user's score. Recently, the pace of development of pachinko machines is accelerating due to installation of sophisticated hardware and software systems that allow users to enjoy amusement or entertainment in gaining prizes or benefits by playing games like gambling. A typical example of the pachinko machine has a small computer screen at the center of the board to display scores gained by the user who plays a pachinko game. Therefore, the pachinko machines are generally controlled or managed by computer systems in the pachinko hall.

In addition, various game devices are sold on the market for home use. Various game programs are also sold on the market and are installed in the game devices in homes. Some of the game programs are designed to simulate the aforementioned game playing machines, so that general home users can play the aforementioned amusement or entertainment games using private game devices at home. Recently, the game devices may have abilities to access various sites such as game sites and shopping sites over networks such as the Internet. Universal resource locators (URL) are generally used to specify the sites. Therefore, the users of the game devices may be able to play games over the networks and also buy goods over the networks.

The aforementioned commodity exchangers installed in the pachinko halls provide relatively small kinds of commodities as prizes of the pachinko game. For this reason, many pachinko players in Japan tend to select a specific commodity, which is used to realize his/her score of the pachinko game. That is, the pachinko player passes the specific commodity to specific personnel administrating a money exchanger installed close to the pachinko hall, so that the specific commodity is converted to money. This unique system is provided particularly for the pachinko games and the like because the Japanese government provides strict restrictions on gambling. However, it is very annoying and inefficient to exchange scores of pachinko games with commodities and the like.

In addition, the money exchanger specifically installed for the pachinko hall is normally set at a certain place to avoid public notice. Such a place may easily encounter crimes such as robbery, which may be a social problem in Japan.

Further, recent developments of information technologies will provide home electronic devices with capabilities to connect with network systems in relation to various types of online businesses. Therefore, it may be demanded to further develop the game playing machines and home game devices to have capabilities of networking and handling online businesses in the future.

### SUMMARY OF THE INVENTION

It is an object of the invention to provide a game playing system that provides many kinds of commodities as prizes for games and is efficient in exchanging scores for desired commodities. This system may aim at raising user's desire or aggressiveness in playing games.

It is another object of the invention to provide a game prize providing method that provides users with prizes or awards online in response to scores at specific game sites specified by universal resource locators (URL) allocated by management servers over networks.

A game playing system of this invention comprises a game device such as a pachinko machine, a management server, and at least one shop server, all of which are interconnected together via a network. The game device is installed at home or at a prescribed game hall (e.g., pachinko hall). When the player operates the game device to play a prescribed game (e.g., pachinko game), its score is communicated to the management server. The management server provides a URL list describing URLs of shop servers that deal with different kinds of commodities or services respectively. Hence, the management server communicates to the game device the URL list allowing the player to select a specific shop server that deals with preferable commodities or services. Then, the player accesses the specific shop server using its URL to select a desired commodity or service as a prize in consideration of the score of the prescribed game. Thus, the shop server automatically sends the prize to the player without charging its cost. Alternatively, the shop server shares a part of the payment of money for purchasing and sending the prize to the player within the prescribed privilege granted for the player in advance. To ensure the payment and transport, the shop server may require the player to enter monetary information such as a credit card number.

In particular, the pachinko machine is designed to have a connectibility and accessibility to the network such as the Internet interconnecting many servers and sites. Hence, the pachinko machine provides the player with prizes and the like by using the network system without charging its cost (e.g., purchasing and transporting cost) to the player. This is very convenient for the player of the pachinko machine installed in the pachinko hall.

### BRIEF DESCRIPTION OF THE DRAWINGS

These and other objects, aspects, and embodiments of the present invention will be described in more detail with reference to the following drawing figures, in which:

FIG. 1 is a system diagram showing an outline configuration of a game playing system including a game terminal, a contents server, and a shop server in accordance with a first embodiment of the invention;

FIG. 2 is a block diagram showing an internal configuration of the game terminal included in the game playing system of FIG. 1;

FIG. 3 is a block diagram showing an internal configuration of the contents server included in the game playing system of FIG. 1;

FIG. 4 is a flowchart showing a part of a game playing process that is performed between the game terminal, contents server and shop server;

FIG. 5 is a flowchart showing another part of the game playing process that is performed between the game terminal, contents server, and shop server;

FIG. 6 is a sequence diagram showing a control sequence showing mutual operations between the game terminal, contents server, and shop server;

FIG. 7 is a system diagram showing an outline configuration of a game playing system including pachinko machines, a management server, and a shop server in accordance with a second embodiment of the invention;

FIG. 8 shows a detailed configuration of a pachinko machine installed in a pachinko hall shown in FIG. 7;

FIG. 9 is a block diagram showing an electronic configuration of the pachinko machine connected with the management server shown in FIG. 8;

FIG. 10 is a flowchart showing a part of a game playing process that is performed between the pachinko machine, management server, and shop server; and

FIG. 11 is a flowchart showing another part of the game playing process that is performed between the pachinko machine, management server, and shop server.

### DESCRIPTION OF THE PREFERRED EMBODIMENTS

This invention will be described in further detail by way of examples with reference to the accompanying drawings.

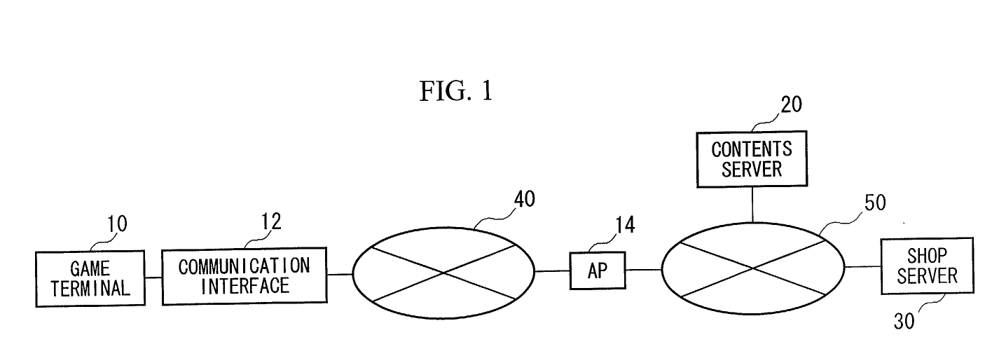

FIG. 1 shows an outline configuration of a game playing system in accordance with a first embodiment of the invention. The game playing system of FIG. 1 comprises a game terminal 10 by which a user (or player) plays a prescribed game online, a contents server (or a management server) 20 that distributes game application software to the game terminal 10, and a shop server 30 that provides the user with commodities or services as a prize (or benefit) for a consideration of a score that is gained by the user playing the game. The game terminal 10 corresponds to a home game device installed in a home, for example.

Specific universal or uniform resource locators (URL) are previously allocated to specify the servers.

The game terminal 10 provides a communication interface 12, by which it is connected to a communication line network 40. The communication line network 40 is also connected to the Internet 50 via a provider 14 (or an application site, abbreviated as ‘AP’). Thus, the game terminal 10 is accessible to the contents server 20 and the shop server 30 via the Internet 50. FIG. 1 shows only a single contents server 20 and a single shop server 30. Actually, however, there may be provided plural contents servers and shop servers, all of which are connected with the Internet 50. In addition, plural game terminals can be included in the present embodiment. The communication interface 12 is a terminal adapter or a modem, for example.

FIG. 2 shows an internal configuration of the game terminal 10. In the game terminal 10, a ROM 100 stores game application software, various types of control programs, and fixed data therein; and a RAM 102 acts as a work area for storing results of games that are played by a user. A CPU 104 implements various functions, for example, a game function enabling execution of games played by the user, a communication function enabling communications with the contents server 20 and the shop sever 30, and a browser function enabling the user to read homepages describing various information regarding prizes that are presented by the shop server 30. A user's manual input section (simply, referred to as a ‘manual input’) 106 provides various types of manual operable members (or manual operators) such as keys, buttons, controls, and switches that are pressed or operated by the user. A display 108 displays a variety of information, pictures, and texts on the screen. That is, when the user plays a game on the game terminal 10 by operating the manual operators of the manual input section 106, the display 108 displays on the screen the progression, transition, and status of the game whose pictures may change rapidly in accordance with the game application software executed by the CPU 104. In addition, when the user operates the game terminal 10 to be connected with the Internet, the display 108 displays on the screen hypertexts and the like of the browsers, which can be changed over upon user's instructions. A communicator (or transmitter) 110 provides a capability to communicate with external devices and systems under the control of the CPU 104.

As the ‘preset’ game application software, the ROM 100 stores in advance prescribed game application programs. The game terminal 10 has capabilities to communicate with prescribed external systems (e.g., game sites) and download desired game application programs that are not included in the preset game application software stored in the ROM 100.

In the present embodiment, the game terminal 10 is designed to download the browser software, which allows the user to read homepages on the Internet, from the contents server 20. Of course, the game terminal 10 can be easily modified to store the browser software without downloading it from the external system.

All of the aforementioned sections and blocks (i.e., ROM 100, RAM 102, CPU 104, user's manual input section 106, display 108, and communicator 110) are mutually interconnected with each other via a bus 120.

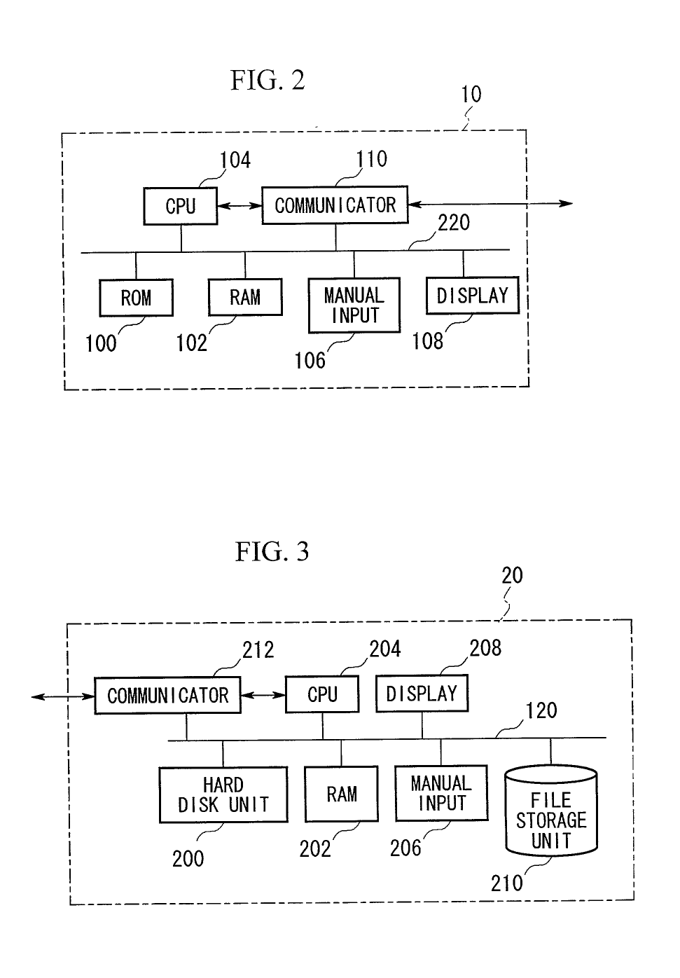

FIG. 3 shows an internal configuration of the contents server 20. In the contents server 20, a hard-disk unit 200 including hard disks stores various types of control programs, Internet browser software, and various types of data therein. The contents server 20 also provides a RAM 202, a CPU 204, a manual input section 206 having a keyboard, a mouse, etc., a display 208, a file storage unit 210, and a communicator 212 for performing communications under the control of the CPU 204.

The file storage unit 210 stores a variety of files, such as a game application software file for electronically distributing various kinds of game application programs to the game terminal 10 online, and a URL file for registering information of universal resource locators (URLs) designating various shop servers respectively. Therefore, the URL file is opened to notify the game terminal 10 of the URL designating its ‘accessible’ shop server. Incidentally, the contents server 20 acts as the management server for the game playing system of this invention. The URL file registers plural URLs designating shop servers whose homepages describe hypertext files presenting information on prizes. In the present embodiment, the contents server 20 is designed to provide different URLs in response to the results or scores of the games that the user plays on the game terminal 10.

When a user finishes a game with a relatively low score, the contents server 20 authorizes the game terminal 10 an accessibility only to the prescribed shop server that deals with daily goods, so that its URL is communicated to the game terminal 10. When the score of the game exceeds a certain number of points in the score, the contents server 20 additionally communicates a URL designating another shop server that deals with home electronics. When the score of the game is even higher, the contents server 20 additionally communicates URLs designating other shop servers that deal with domestic travel, foreign travel, jewelry, and precious metals, for example. As described above, the contents server 20 communicates different URLs, designating shop servers dealing with different kinds of goods and commodities, to the game terminal 10 in response to the results or scores of the games.

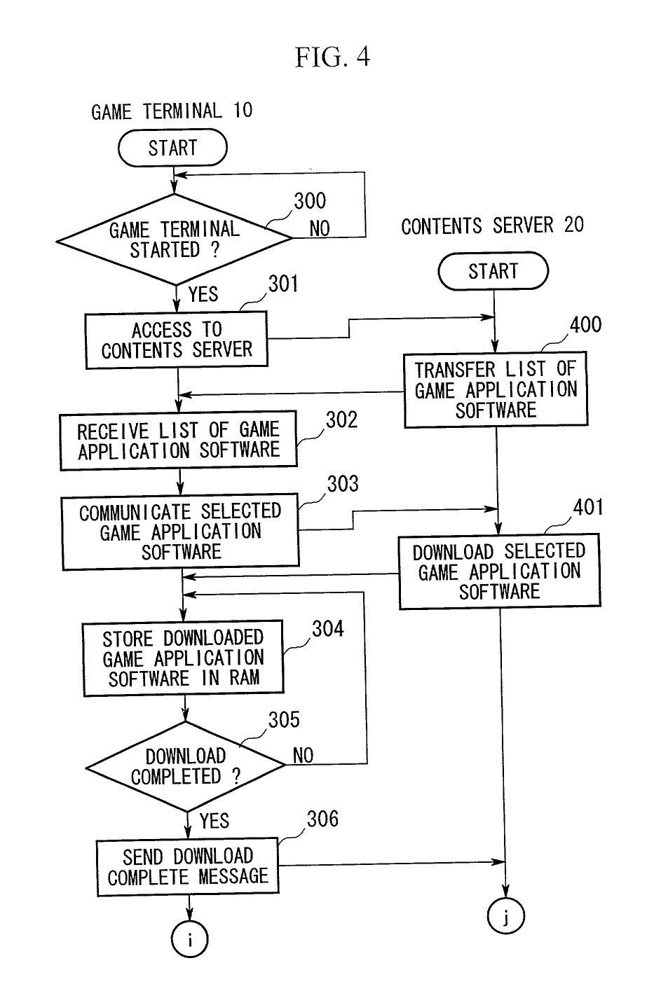

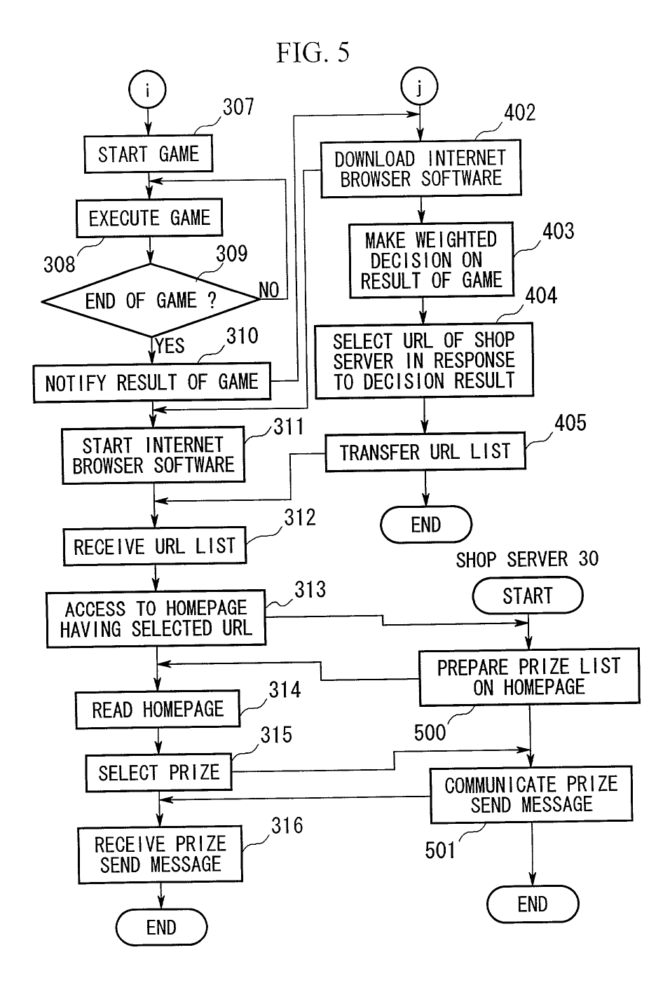

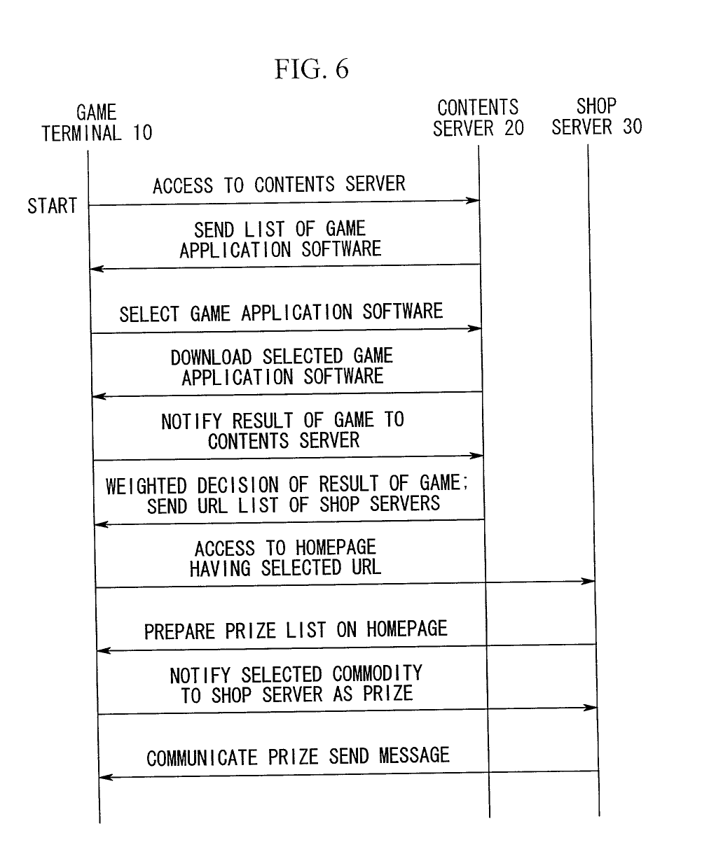

Next, detailed operations of the game terminal 10, contents server 20, and shop server 30 will be described with reference to a combined flowchart shown in FIGS. 4 and 5. This flowchart is provided to represent details of a control sequence shown in FIG. 6 that is established between the game terminal 10, contents server 20, and shop server 30. Specifically, this flowchart is a combination of three routines, wherein a routine started from step 300 is related to the game terminal 10; a routine started from step 400 is related to the contents server 20; and a routine started from step 500 is related to the shop server 30.

In FIG. 4, the game terminal 10 is set in a standby state waiting for an entry of a start command or instruction therefor in step 300. When the user (or player) starts the game terminal 10, the flow proceeds to step 301 in which the user operates the manual input section 106 of the game terminal 10 to access the contents server 20, so that the game terminal 10 issues a distribution request to the contents server 20 to allow distribution of the prescribed game application software (that is, game application programs). Upon receipt of the distribution request from the game terminal 10, the contents server 20 reads from the file storage unit 210 a list of game application programs, which is then transferred to the game terminal 10 online in step 400.

In step 302, the game terminal 10 receives the list of game application programs (namely, the game list) from the contents server 20, so that the game terminal 10 displays it on the screen of the display 108. Herein, titles of the game application programs are displayed on the screen of the display 108 and are provided for the user's selection. Thus, the user selects a specific game application program (e.g., a game application program of a pachinko game) on the game terminal 10. In step 303, the game terminal 10 communicates to the contents server 20 via the communicator 110 a message that the user selects a game application program of the pachinko game.

Upon receipt of the aforementioned message from the game terminal 10, the contents server 20 reads from the file storage unit 210 the selected game application program, which is then downloaded to the game terminal 10 in step 401.

The game terminal 10 receives and stores the ‘downloaded’ game application program of the pachinko game in the RAM 102 in step 304. Receiving and storing operations are retained (see step 305) until the contents server 20 completes downloading of the game application program to the game terminal 10. When the contents server 20 completes the downloading so that the game terminal 10 completely receives and stores the game application program in the RAM 102, the flow proceeds to step 306 in which the game terminal 10 sends a download complete message to the contents server 20. Thus, it is possible to completely store the game application program of the pachinko game in the RAM 102, so that the game terminal 10 has a capability of functioning as a pachinko machine.

In FIG. 5, when the user operates a prescribed start key of the manual input section 106 in step 307, the game terminal 10 starts to execute the pachinko game, which is played by the user who operates the manual input section 106 in step 308. The execution of the pachinko game is continued (see step 309) until the user operates a prescribed end key of the manual input section 106. When the user ends the pachinko game, the game terminal 10 counts the total points of the pachinko game, so that a total score or result of the pachinko game is notified to the contents server 20 in step 310. In the case of a pachinko game, its score represents the total number of balls (actually, images of balls virtually displayed on the screen) that the user gains and holds after finishing the game.

If the game terminal 10 issues a browser software transfer request, the contents server 20 downloads the Internet browser software to the game terminal 10 in step 402. Therefore, the game terminal 10 is capable of starting the Internet browser software in step 311.

In the contents server 20, the score or result of the pachinko game notified from the game terminal 10 is subjected to weighted decisions in step 403. In response to the results of the weighted decisions, the contents server 20 selects one or more URLs designating shop servers in step 404. In step 405, the contents server 20 transfers a list of the selected URLs to the game terminal 10 online.

In response to the results of the weighted decisions, the contents server 20 also sends to the game terminal 10 monetary information representing upper limits of prices for goods or services that the user can select by the score of the pachinko game.

In step 312, the game terminal 10 receives the list of the selected URLs (namely, the URL list) from the contents server 20. Thus, the game terminal 10 makes an access to a prescribed shop server (i.e., shop server 30) designated by a desired URL described on the URL list in step 313.

In addition, the shop server 30 prepared a prize list describing prescribed prizes on the homepage thereof When being accessed by the game terminal 10 via the provider 14, the shop server 30 provides the prize list on the homepage in step 500.

In step 314, the user reads the homepage of the shop server 30 on the screen of the display 108 of the game terminal 10. In step 315, the user selects a desired prize (e.g., a commodity or service) on the prize list described in the homepage of the shop server 30. Thus, the game terminal 10 notifies the shop server 30 online of the desired prize that is selected by the user. To authorize the payment of money, the shop server 30 may request accounting or charging information such as a credit card number, an ID number, etc.

Upon notification of the selected prize from the game terminal 10, the shop server 30 in turn notifies the game terminal 10 of a prize send message for sending the prize to the user in step 501.

In step 316, the game terminal 10 receives the prize send message from the shop server 30. Therefore, the user of the game terminal 10 may wait for the prize to be sent thereto. In this case, the manager of the contents server 20 bears a burden for charges of commodities or services, which are provided as prizes from the shop server 30, as well as a burden for sending privileges of games (such as bonus points representing small amounts of money presented for game players). Herein, the user of the game terminal 10 may share a part of the payment of money that exceeds the prescribed privilege of the pachinko game, for example.

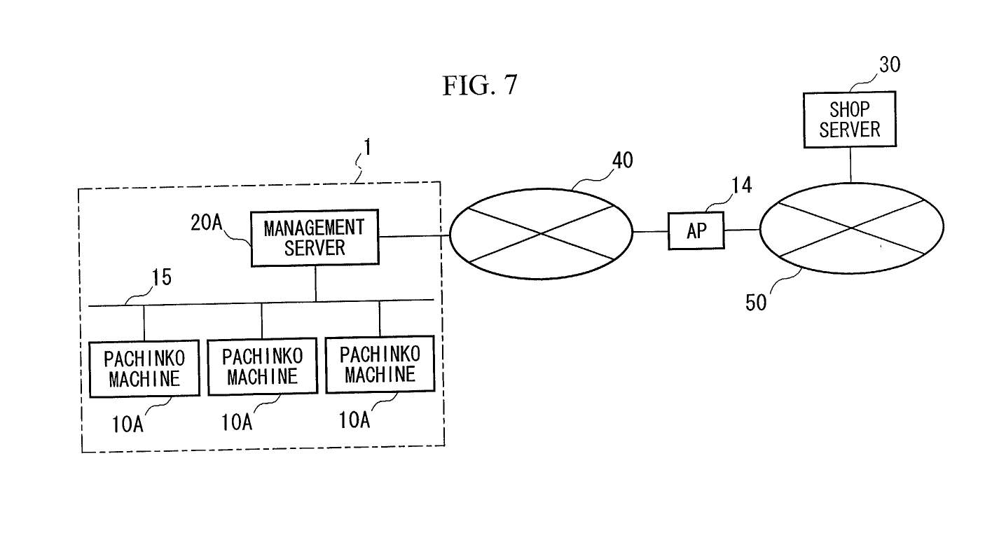

FIG. 7 shows an outline configuration of a game playing system in accordance with a second embodiment of the invention, wherein parts identical to those shown in FIG. 1 are designated by the same reference numerals. The game playing system of the second embodiment is provided for a pachinko hall 1 that contains plural pachinko machines 10A and a management server 20A. Herein, the management server 20A manages the pachinko machines 10A. In addition, the shop server 30 provides commodities and services as prizes or privileges for players of the pachinko machines 10A.

All of the pachinko machines 10A are connected to the management server 20A via a local area network (i.e., LAN) 15 installed in the pachinko hall 1. The management server 20A is connected to the communication line network 40, from which it is also connected to the Internet 50 via a provider 14. Hence, the management server 20A installed in the pachinko hall 1 is connectible to the shop server 30 online. FIG. 7 shows a single shop server 30; actually however, there are provided plural shop servers, which are omitted to simplify the illustration.

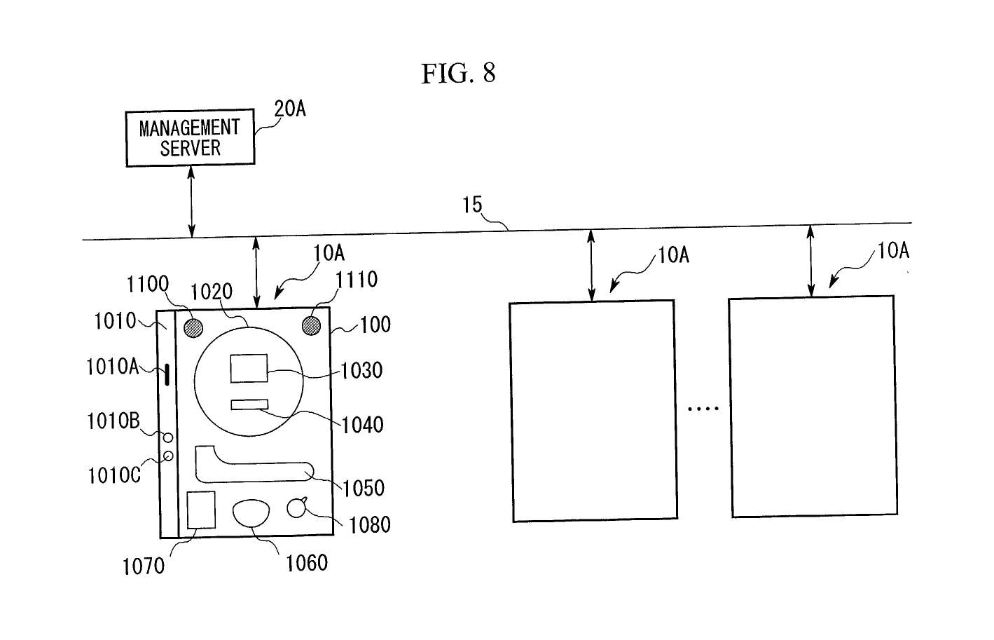

FIG. 8 shows a detailed configuration of the pachinko machine 10A installed in the pachinko hall 1. At the left side of the pachinko machine 10A, there is provided a card unit 1010 that comprises a card slot 1010A allowing insertion of a card (e.g., a prepaid card or a credit card), a ball distribution button 1010B, and a card eject button 1010C.

At the upper center area of the board of the pachinko machine 10A, there is provided a play area 1020 in which a small metal ball (simply referred to as a ball) is shot and then falls while changing its course by being interrupted by pins, which are planted in a prescribed arrangement. At approximately the center position of the play area 1020, there is provided a display 1030 having a small rectangular screen. Below the display 1030, there is provided an attacker 1040, i.e., an open/close plate that may periodically open and close to receive or block the ball therein.

The pachinko hall 1 employs a ball distribution system to supply the player with balls for a fee. That is, when the player inserts the card into the card slot 1010A of the card unit 1010, the pachinko machine 10A automatically supplies the player with the prescribed number of balls, which are used to start a pachinko game. When a ball shot into the play area 1020 successfully falls into a hole in the play area 1020, the pachinko machine 10A supplies the user with a prescribed multiple number of balls. These balls are supplied and accumulated in an upper tray 1050. A lower tray 1060 is arranged below the upper tray 1050. An operation panel 1070 is arranged at the left side of the lower tray 1060, and a ball shooting handle (simply referred to as a handle) 1080 is arranged at the right side of the lower tray 1060. In addition, the pachinko machine 10A also provides speakers 1100 and 1110 that produces musical tones, sound effects, and the like.

Specifically, every time the player inserts the card into the card slot 1010A and presses the ball distribution button 1010B, the prescribed number of balls are automatically distributed to the upper tray 1050 in response to the prescribed unit of money, which is withdrawn from the card. When the player presses the card eject button 1010C, the card is automatically ejected from the card slot 1010A.

When the player manipulates the handle 1080 to rotate in a clockwise or counterclockwise direction, a ball from among balls supplied in the upper tray 1050 is shot along the prescribed circular peripheral course and is then released into the play area 1020 on the board of the pachinko machine 10A. Herein, the ball is shot with a certain force and at a certain speed in response to an amount of manipulation of the handle 1080. The display 1080 normally displays various types of pictures on the screen thereof. When the ball initially shot by the player successfully falls into wining holes (not shown) arranged at prescribed positions in the play area 1020, the display 1030 automatically changes pictures displayed on the screen. For example, the display 1030 displays on the screen three digits, which are horizontally arranged and each of which is independently changed over every time a ball successfully falls into the prescribed hole in the play area 1020. Therefore, the player expects prescribed combinations of digits to be displayed on the screen of the display 1030. When the display 1030 displays a specific picture on the screen, for example, when the display 1030 shows ‘777’ on the screen for a while, the player makes a bit hit in the pachinko game, so that the pachinko machine 10A automatically opens the attacker 1040 that is normally closed to block balls. Therefore, a relatively large number of balls can fall into a big hole that opens behind the attacker 1040 being opened. The attacker 1040 is opened for the prescribed time period, or it is open until the prescribed number of balls fallen into the big hole is completely counted. In short, when the player makes a bit hit in the pachinko game, the pachinko machine 10A provides a profitable or beneficial condition to the player by automatically opening the attacker 1040. Therefore, the player will make every effort to speedily shoot balls into the play area 1020 of the pachinko machine 10A.

Every time a ball falls into the big hole behind the attacker 1040, the pachinko machine 10A provides the prescribed multiple number of balls, which are distributed onto the upper tray 1050. Balls that fail to fall into holes of the play area 1020 are discharged from the pachinko machine 10A via a discharge hole (not shown). When the hollow space of the upper tray 1050 is fully occupied with balls, excess balls overflowing from the upper tray 1050 are brought into the lower tray 1060. The speakers 1100 and 1110 arranged at upper left and right positions of the pachinko machine 10A continuously produce musical tones of the prescribed musical tune (or sound-effects music) in response to the progression of the pachinko game.

After the player starts the pachinko game, the pachinko machine 10A periodically transmits play status management data to the management server 20A via the LAN 15. The play status management data represent the number of balls shot into the play area 1020, the number of ‘discharged’ balls, the number of bit hits made by the player, and the like. The play status management data are used for the management of the pachinko hall 1. In addition, the play status management data are used for adjustments of pins arranged in the play area 1020 of the pachinko machine 10A. That is, a specialized expert adjusts pitches between the pins in consideration of the play status management data.

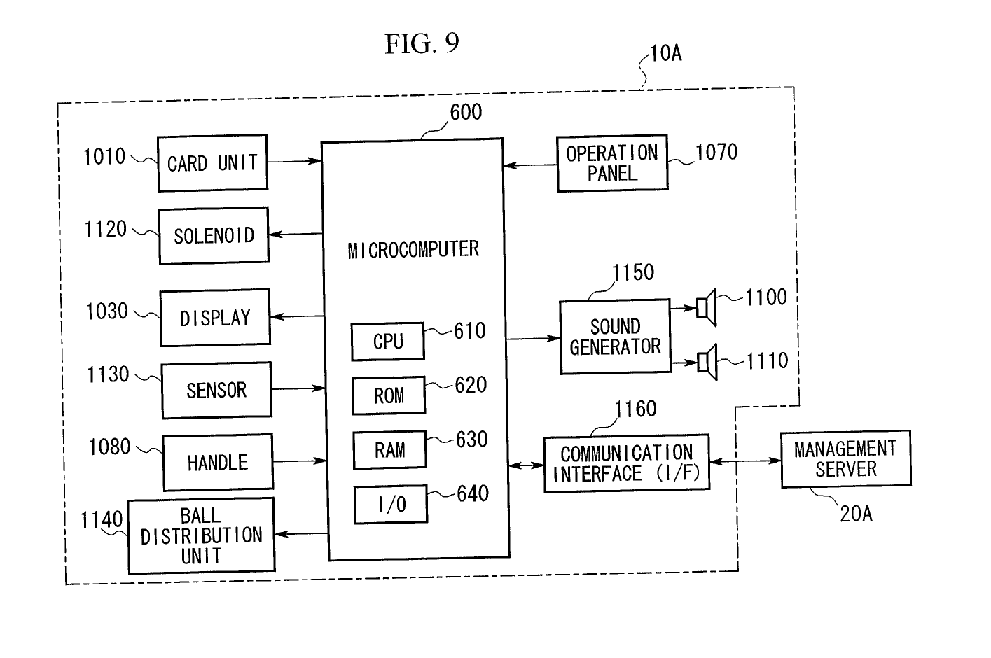

FIG. 9 shows an electronic configuration of the pachinko machine 10A. In addition to the aforementioned card unit 1010, display 1030, operation panel 1070, handle 1080, speakers 1100 and 1110, the pachinko machine 10A also comprises a solenoid 1120, a sensor 1130, a ball distribution unit 1140, a sound generator 1150, a communication interface 1160, and a microcomputer 600. Herein, the sound generator 1150 generates musical tone signals of the prescribed musical tune, so that corresponding musical tones are produced by the speakers 1100 and 1110.

The microcomputer 600 is provided to control various blocks and sections of the pachinko machine 10A, and it comprises a CPU 610, a ROM 620 for storing various kinds of programs and fixed data, a RAM 630, and an input/output interface (I/O) 640.

Specifically, the microcomputer 600 receives from the card unit 1010 prescribed information and data regarding insertion and ejection of a card in the card slot 1010A, and operations of the ball distribution button 1010B. That is, when the microcomputer 600 inputs operation information of the ball distribution button 1010B, it instructs the ball distribution unit 1140 to distribute the prescribed number of balls worth the payment of the prescribed amount of money, which is withdrawn from the card. The solenoid 1120 drives the attacker (i.e., open/close plate) 1040. When the player makes a big hit, the solenoid 1120 drives the attacker 1140 to open for a while.

The sensor 1130 detects whether or not a ball successfully falls into a prescribed lottery activating hole of the play area 1020 or a big hole behind the attacker 1040. Based on the detection result, the microcomputer 600 performs calculations to control the display 1030 and the ball distribution unit 1140. For example, when a ball successfully falls into the prescribed lottery activating hole of the play area 1020 so that the sensor 1130 detects a ‘wining shot’, the microcomputer 600 instructs the ball distribution unit 1140 to distribute the prescribed multiple number of balls while controlling the display 1030 to change its image; thereafter, the microcomputer 600 makes a decision as to whether or not the changed image matches the prescribed image pattern (e.g., ‘777’), that is, the microcomputer 600 makes a decision as to whether or not the player draws a lot, or whether or not the player makes a big hit. In the case of the big hit, for example, the microcomputer 600 drives the solenoid 1120 to open the attacker 1040 for the prescribed time period, and it also instructs the ball distribution unit 1140 to distribute the prescribed multiple number of balls every time a ball successfully falls into the big hole behind the attacker 1040.

When the player manipulates the handle 1080, a ball is shot into the play area 1020 and is then released. Every time a ball is shot into the play area 1020, the handle 1080 supplies the microcomputer 600 with ball shooting data. Specifically, the microcomputer 600 manages the following information and data.

(i) The number of ‘distributed’ balls that are distributed when the player presses the ball distribution button 1010B after the insertion of a card into the card slot 1010A and that are also distributed in response to a detection signal that is output from the sensor 1130 detecting a wining shot.

(ii) The number of ‘shot’ balls, which is represented by the ball shooting data output from the handle 1080.

(iii) The result of the determination of a big hit, which is represented by big hit information.

Therefore, the microcomputer 600 transfers the aforementioned information and data to the management server 20A via the communication interface 1160 at the prescribed timing.

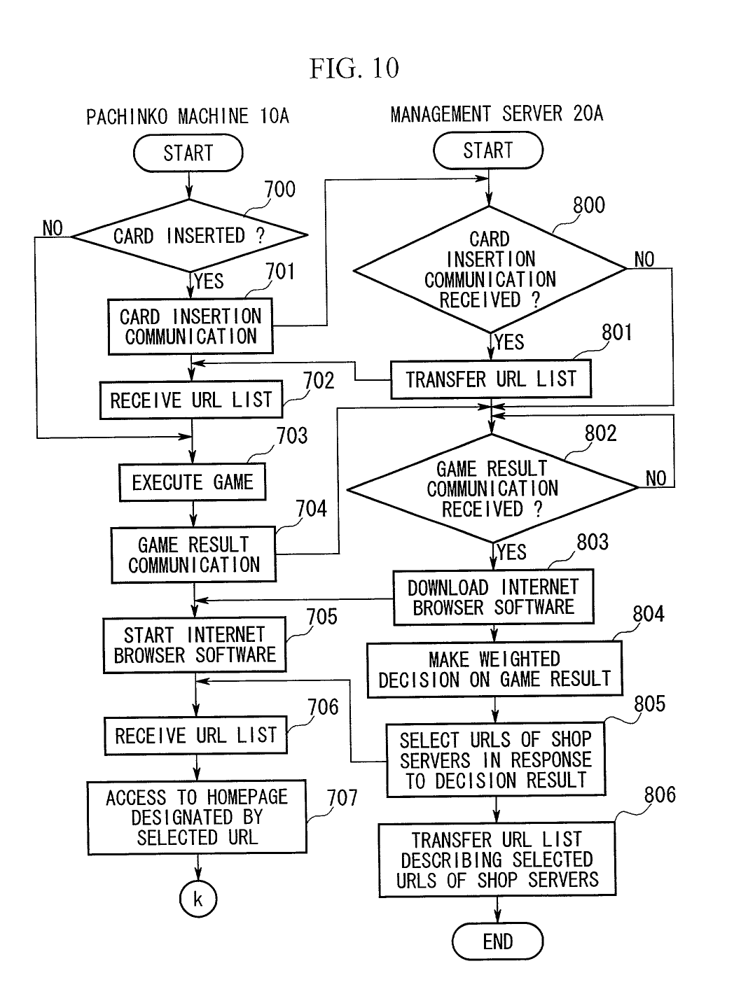

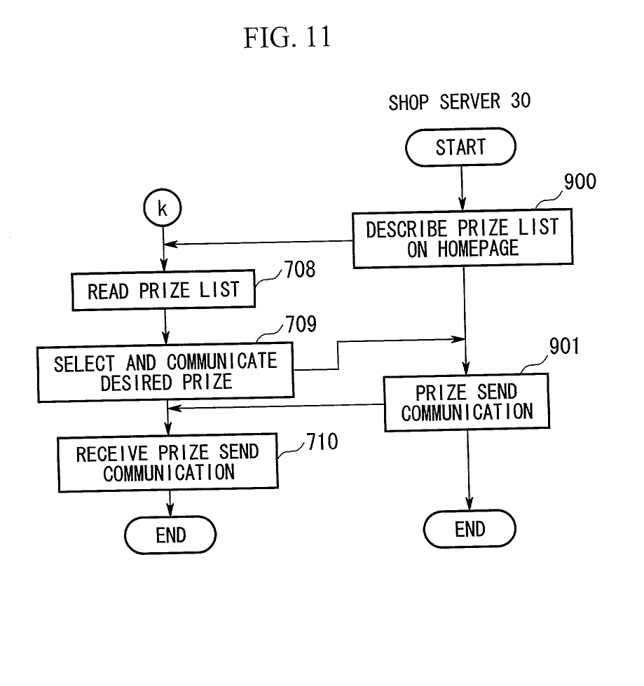

Next, operations of the game playing system of the second embodiment, which is mainly composed of the pachinko machine 10A, management server 20A, and shop server 30, will be described with references to a combined flowchart shown in FIGS. 10 and 11. Like the foregoing flowchart shown in FIGS. 4 and 5, this flowchart is a combination of three routines, wherein a routine started from step 700 is related to the pachinko machine 10A; a routine started from step 800 is related to the management server 20A; and a routine started from step 900 is related to the shop server 30.

Initially, the pachinko machine 10A is set in a standby state waiting for an insertion of a card into the card slot 1010A of the card unit 1010 (see step 700 shown in FIG. 10). When the player inserts a card into the card slot 1010A of the pachinko machine 10A, a decision result of step 700 is ‘YES’ so that the flow proceeds to step 701, wherein the microcomputer 600 sends a card insertion communication to the management server 20A via the communication interface 1160.

The management server 20A is initially set in a standby state waiting for the receipt of a card insertion communication that is sent thereto from the pachinko machine 10A (see step 800). Upon receipt of the card insertion communication, the management server 20A is notified from the pachinko machine 10A that the player will start a pachinko game. Therefore, a decision result of step 800 is ‘YES’ so that the flow proceeds to step 801, wherein the management server 20A transfers to the pachinko machine 10A a URL list describing shop servers that are accessible for the pachinko game and that provide homepages describing prize information. For example, the management server 20A selected in advance prescribed shop servers that deal with daily goods.

In step 702, the pachinko machine 10A receives the URL list from the management server 20A. In step 703, the pachinko machine 10A executes a pachinko game.

After the pachinko game is ended, the pachinko machine 10A counts and accumulates results of the pachinko game; then, the results are sent to the management server 20A as a game result communication in step 704. When the management server 20A receives the game result communication from the pachinko machine 10A, a decision result of step 802 is ‘YES’ so that the flow proceeds to step 803. In step 803, the management server 20A downloads the Internet browser software to the pachinko machine 10A in response to a request from the pachinko machine 10A. In step 705, the pachinko machine 10A receives and starts the Internet browser software.

In step 804, the management server 20A makes weighted decisions on the results of the pachinko game transmitted thereto from the pachinko machine 10A. In step 805, the management server 20A selects one or more shop servers in response to the results of the weighted decisions. In step 806, the management server 20A creates an URL list describing URLs of the selected shop servers, so that the URL list is transferred to the pachinko machine 10A.

In the above, the management server 20A also provides monetary information representing upper limits of money for commodities or services, which can be selected in response to the results of the weighted decisions. Hence, the management server 20A sends the monetary information to the pachinko machine 10A.

In step 706, the pachinko machine 10A receives the URL list transferred thereto from the management server 20A. Hence, the player of the pachinko machine 10A selects a desired shop server whose URL is described in the URL list. In step 707, the pachinko machine 10A accesses to the ‘desired’ shop server 30 whose URL is selected from the URL list.

The shop server 30 prepared a homepage describing a prize list in step 900. Hence, when the pachinko machine 10A accesses the shop server 30 via the provider 14, it allows the player to read the prize list on the homepage in step 708. In step 709, the player can select a desired prize from the prize list on the homepage, so that the selected prize is communicated to the shop server 30. When selecting the desired prize (i.e., desired commodity) from the prize list, the player is requested to input accounting or charging information such as the credit card number and ID number.

Through reading the homepage of the shop server, when the player judges that the prize list does not describe the desired commodity or service, the player may be able to restart the pachinko game in step 703. In addition, if the player judges that a higher score of the pachinko game is required to obtain the desired commodity or service, the player may be able to restart the pachinko game in step 703.

When the shop server 30 receives a communication representing the selected prize from the pachinko machine 10A, it sends a prize send communication to the pachinko machine 10A in step 901.

The pachinko machine 10A receives the prize select communication from the shop server 30 in step 710. Therefore, the player may wait for the prize to be transported. Incidentally, the second embodiment is designed similarly to the first embodiment with respect to the monetary service for sharing the payment. That is, the manager of the management server 20A of the pachinko hall 1 bears a burden for the charge of the commodity or service that is provided from the shop server 30 as the prize for the pachinko game. In addition, the manager of the management server 20A also bears a burden for the prescribed privilege (e.g., the prescribed amount of money) for the pachinko game. Herein, the player of the pachinko machine 10A may share a part of the payment of money that exceeds the privilege granted therefor in advance.

The second embodiment describes the pachinko machine 10A as an example of the game terminal for use in the game playing system. Of course, the game playing system of the second embodiment is applicable to other devices and machines such as the patisuro machine, arcade game machine, pinball machine, and slot machine. Herein, the patisuro machine having rotatable reels is played using medals.

According to the first and second embodiments of this invention, the game playing system is designed in such a manner that the player of the game terminal or pachinko machine is capable of directly accessing the desired shop server whose URL is selected from the URL list provided by the management server and the like; therefore, the player can directly select and receive the desired prize from the desired shop server. That is, the game playing system provides plenty of prizes or privileges to the player; hence, it is possible to broaden the range of prizes or privileges that can be provided for the player.

The game playing system of the foregoing embodiments provides a variety of shop servers whose homepages describe different kinds of commodities and services as prizes. Therefore, it is possible to raise the desire and aggressiveness of the player to play the game.

The player is capable of exchanging or transacting commodities of prizes via the network by simply operating the game terminal and the like. This allows the exchange and transaction of the prizes efficiently online.

Incidentally, the game playing system is not necessarily designed to have accessibility to prescribed shop servers. Hence, the system can easily access to other servers or sites, that is, information providing sites such as shopping sites.

As this invention may be embodied in several forms without departing from the spirit or essential characteristics thereof, the present embodiments are therefore illustrative and not restrictive, since the scope of the invention is defined by the appended claims rather than by the description preceding them, and all changes that fall within metes and bounds of the claims, or equivalents of such metes and bounds, are therefore intended to be embraced by the claims.

What is claimed is:

1. A game prize providing method comprising the steps of:
allowing a player to play a prescribed game on a game device;
transmitting a score of the prescribed game to a management server that is connected to the game device over a network and manages the game device; and
providing the game device with location information specifying an information providing site that provides prize information in response to the score of the prescribed game via the network.

2. A game prize providing method according to claim 1, wherein upon receipt of the score of the prescribed game, the management server automatically provides the game device with the location information specifying the information providing site.

3. A game prize providing method according to claim 1 further comprising the steps of:
allowing the player to access and read a homepage of the information providing site specified by the location information that is provided from the management server; and
allowing the player to select a desired prize listed on the homepage of the information providing site.

4. A game prize providing method according to claim 3 further comprising the step of:
automatically providing the player with the desired prize based on the score of the prescribed game.

5. A game prize providing method according to claim 1, wherein the game device is installed in a home or at a game hall.

6. A game prize providing method according to claim 1, wherein the information providing site is a shopping site whose homepage can be read by prescribed browser software.

7. A game prize providing method according to claim 1, wherein the game device comprises a game provider for providing the prescribed game, a transmitter for transmitting the score of the prescribed game to the management server, and a receiver for receiving location information specifying the information providing site for providing the prize information online.

8. A game prize providing method according to claim 7, wherein the game device further comprises a reader for allowing the player to read a homepage of the information providing site specified by the location information provided from the management server, and a selector for allowing the player to select a desired prize on the homepage of the information providing site.

9. A game prize providing method according to claim 7, wherein the game device is installed at home or at a prescribed game hall.

10. A game prize providing method according to claim 7, wherein the information providing site is a shopping site whose homepage can be read by prescribed browser software.

11. A game prize providing method according to claim 1, wherein the management server comprises a receiver for receiving the score of the prescribed game from the game device via the network, and a location information provider for providing the game device with the location information specifying the information providing site in response to the score of the prescribed game.

12. A game prize providing method according to claim 11, wherein the game device is installed in a home or at a prescribed game hall.

13. A game prize providing method according to claim 11, wherein the information providing site is a shopping site whose homepage can be read by prescribed browser software.

14. A game prize providing method according to claim 1, wherein the prescribed game is a pachinko game whose score is counted as a multiple of the number of balls that fall into a prescribed hole on a board.

15. A game playing system comprising:
a game device for allowing a player to play a prescribed game;
a management server for connecting the game device via a network and for managing the game device via the network; and
a shop server for providing commodities or services via the network,
wherein the management server automatically providing the game device with location information specifying the shop server in response to a score of the prescribed game notified thereto from the game device, so that the player is allowed to select a desired commodity or service described on a homepage of the shop server specified by the location information based on the score of the prescribed game.

16. A game playing system according to claim 15, wherein the prescribed game is a pachinko game whose score is counted as a multiple of the number of balls that fall into a prescribed hole on a board.

17. A game playing system according to claim 15, wherein the management server provides the game device with a location information list describing a plurality of shop servers that deal with different kinds of commodities or services respectively in response to the score of the prescribed game, so that the player of the game device is allowed to select a desired shop server whose location information is described on the location information list.

18. A game playing system according to claim 15, wherein the management server automatically provides the player of the game device with the desired commodity or service as a prize based on the score of the prescribed game without charging its cost to the player.

19. A game playing system according to claim 15, wherein the management server automatically provides the player of the game device with the desired commodity or service as a prize based on the score of the prescribed game while sharing at least a part of a cost of the desired commodity or service within a prescribed privilege granted for the player in advance.

20. A game playing system according to claim 15, wherein the game device is a pachinko machine in which a prescribed number of balls are distributed for the player to start a pachinko game and are sequentially shot onto a board, so that a multiple of the number of balls that fall into a prescribed hole without being discharged is counted as a score of the pachinko game.

21. A game playing system according to claim 20, wherein the pachinko machine has a display for displaying images or digits for a lottery, so that when a ball falls into a prescribed lottery activating hole on the board, the display changes its images or digits to check for a match of a prescribed pattern of images or digits designating a big hit for providing the player with a special chance to gain a greater number of balls.

22. A game playing system according to claim 20, wherein the player uses a card for payment of money required for distribution of the balls in the pachinko game.

23. A game playing system according to claim 20, wherein the player enters monetary information allowing the shop server to provide a prize for a consideration of the score of the pachinko game.
